(19) United States
(12) Patent Application Publication
(10) Pub. No.: US 2014/0234532 A1
(43) Pub. Date: Aug. 21, 2014

(54) LAMINATED COMPOSITE MATERIAL FOR PRODUCING DISPLAY ELEMENT, OPTICAL ELEMENT, OR ILLUMINATION ELEMENT

(71) Applicant: SUMITOMO BAKELITE CO., LTD., Shinagawa-ku (JP)

(72) Inventors: Hideo UMEDA, Kobe-shi (JP); Ritsuya KAWASAKI, Kobe-shi (JP); Toshihiko KATAYAMA, Kobe-shi (JP); Yusuke INOUE, Kobe-shi (JP); Jun OKADA, Kobe-shi (JP); Mizuho INOUE, Kobe-shi (JP); Manabu NAITO, Kobe-shi (JP)

(73) Assignee: SUMITOMO BAKELITE CO., LTD., Shinagawa-ku (JP)

(21) Appl. No.: 14/178,618

(22) Filed: Feb. 12, 2014

Related U.S. Application Data
(60) Provisional application No. 61/765,309, filed on Feb. 15, 2013.

(51) Int. Cl. C08G 73/02; C03C 17/32

(52) U.S. Cl. CPC C08G 73/026; C03C 17/32
USPC 427/58; 524/607; 428/435; 428/337; 428/339

(57) ABSTRACT

This disclosure, viewed from one aspect, relates to a laminated composite material, including a glass plate and an organic resin layer. The organic resin layer is laminated on one surface of the glass plate, the organic resin is a polyamide resin, the rate of mass change of the polyamide resin from 300° C. to 400° C. measured by thermo gravimetry (TG) is 3.0% or less, and the glass transition temperature of the polyamide resin is 300° C. or more.

### CROSS REFERENCE TO RELATED APPLICATIONS

The disclosure is based upon and claims priority from U.S. Provisional Application Ser. No. 61/765,309, filed Feb. 15, 2013, the disclosure of which is hereby incorporated by reference herein in its entirety.

### TECHNICAL FIELD

The disclosure of the present specification relates to a laminated composite material for producing display element, optical element, or illumination element; a solution of polyamide for use in a process for manufacturing the laminated composite material; a process for manufacturing a display element, an optical element or an illumination element; a display element, an optical element or an illumination element; and the like.

### BACKGROUND ART

As transparency is required of display elements, glass substrates using a glass plate have been used as substrates for the elements (JP10311987 (A)). However, for display elements using a glass substrate, problems such as being heavy in weight, breakable and unbendable have been pointed out at times. Thus, the use of a transparent resin film instead of a glass substrate has been proposed.

For example, polycarbonates, which have high transparency, are known as transparent resins for use in optical applications. However, their heat resistance and mechanical strength can be an issue when using them in manufacturing display elements. On the other hand, examples of heat resistant resins include polyimides. However, typical polyimides are brown-colored, and it can be an issue for use in optical applications. As polyimides with transparency, those having a ring structure are known. However, the problem with such polyimides is that they have poor heat resistance.

WO 2012/129422 discloses a transparent polyamide film with thermal stability and dimension stability. This transparent film is manufactured by casting a solution of aromatic polyamide and curing the casted solution at a high temperature. The document discloses that the cured film has a transmittance of more than 80% over a range of 400 to 750 nm, a coefficient of thermal expansion (CTE) of less than 20 ppm/° C., and shows favorable solvent resistance. And the document discloses that the film disclosed can be used as a flexible substrate for a microelectronic device.

### SUMMARY

One aspect of this disclosure relates to a laminated composite material, including a glass plate and an organic resin layer. The organic resin layer is laminated on one surface of the glass plate, the organic resin is a polyamide resin, the rate of mass change of the polyamide resin from 300° C. to 400° C. measured by thermo gravimetry (TG) is 3.0% or less, and the glass transition temperature of the polyamide resin is 300° C. or more.

Further, one aspect of this disclosure relates to a solution of polyamide for use in a process for manufacturing the laminated composite material. The solution of polyamide includes an aromatic polyamide and a solvent.

Furthermore, one aspect of this disclosure relates to a process for manufacturing a display element, an optical element or an illumination element, and the process includes the step of forming the display element, the optical element or the illumination element on a surface of the organic resin layer of the laminated composite material, the surface not opposing the glass substrate. Further, one aspect of this disclosure relates to a display element, an optical element or an illumination element manufactured by the process.

### BRIEF DESCRIPTION OF THE DRAWINGS

FIG. 1 is a schematic cross-sectional view showing a configuration of an organic EL element 1 according to one embodiment.

FIG. 2 is a flow chart for explaining a process for manufacturing an OLED element according to one embodiment.

FIG. 3 is a flow chart for explaining a process for manufacturing an OLED element according to one embodiment.

FIG. 4 is a flow chart for explaining a process for manufacturing an OLED element according to one embodiment.

### DETAILED DESCRIPTION

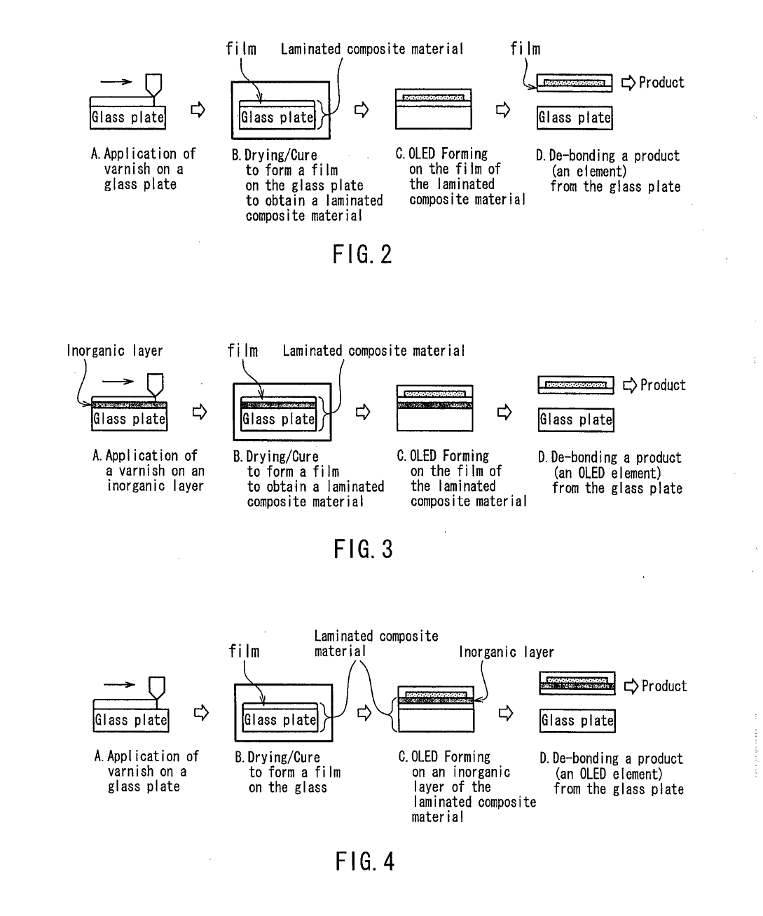

A display element, an optical element, or an illumination element such as an organic electro-luminescence (OEL) or organic light-emitting diode (OLED) is often produced by the process described in FIG. 2. Briefly, a polymer solution (varnish) is applied or casted onto a glass base or a silicon wafer base (step A), the applied polymer solution is cured to form a film (step B), an element such as OLED is formed on the film (step C), and then, the element such as OLED (product) is de-bonded from the base (step D). These days, polyimide film is used as the film in the process in FIG. 2.

With regard to the process for manufacturing a display element, an optical element or an illumination element as described in FIG. 2, it was found that curvature deformation of the laminated composite material including a glass plate and a film obtained in the step B caused reductions in quality and yield. That is, it was found that when the laminated composite material suffered curvature deformation, it would present problems, such as causing difficulty in transferring the material during the manufacturing process, leading to changes in exposure strength during patterning, thereby causing difficulty in forming a uniform pattern and/or allowing the development of cracks in an inorganic barrier layer when being laminated. And with regard to these problems, it was found that the use of a polyamide film satisfying certain conditions would significantly suppress curvature deformation of the laminated composite material.

In one or plurality of embodiments, this disclosure relates to a laminated composite material with suppressed curvature deformation. Further, in one or plurality of embodiments, this disclosure relates to a laminated composite material with suppressed curvature deformation and/or improved dimension stability.

[Laminated Composite Material]

The term “laminated composite material” as used herein refers to a material in which a glass plate and an organic resin layer are laminated. In one or plurality of non-limiting embodiments, a glass plate and an organic resin layer being laminated means that the glass plate and the organic resin layer are laminated directly. Alternatively, in one or plurality of non-limiting embodiments, it means that the glass plate and the organic resin layer are laminated through one or more layers. Herein, the organic resin of the organic resin layer is a polyamide resin. Thus, in one or plurality of embodiments, the laminated composite material of this disclosure includes a glass plate and a polyamide resin layer, and the polyamide resin is laminated on one surface of the glass plate.

In one or plurality of non-limiting embodiments, the laminated composite material according to this disclosure can be used in a process for manufacturing a display element, an optical element or an illumination element, such as in one described in FIG. 2. Further, in one or plurality of none-limiting embodiments, the laminated composite material according to this disclosure can be used as a laminated composite material obtained by the step B of the manufacturing process described in FIG. 2. Therefore, in one or plurality of none-limiting embodiments, the laminated composite material according to this disclosure is a laminated composite material for use in a process for manufacturing a display element, an optical element or an illumination element, including the step of forming the display element, the optical element, or the illumination element on a surface of the organic resin layer, wherein the surface is not opposed to a glass plate.

The laminated composite material according to this disclosure may include additional organic resin layers and/or inorganic layers in addition to the polyamide resin layer. In one or plurality of none-limiting embodiments, examples of additional organic resin layers include a flattening coat layer.

Further, in one or plurality of none-limiting embodiments, examples of inorganic layers include a gas barrier layer capable of suppressing permeation of water, oxygen, or the like and a buffer coat layer capable of suppressing migration of ions to TFT element.

FIG. 3 shows one or plurality of none-limiting embodiments in which an inorganic layer is formed between the glass plate and the polyamide resin layer. The inorganic layer in the embodiments may be, for example, an amorphous Si layer formed on the glass plate. Polyamide varnish is applied onto the amorphous Si layer on the glass plate in the step A, and then the applied varnish is dried and/or cured in the step B, thereby forming the laminated composite material. In the step C, a display element, an optical element, or an illumination element is formed on the polyamide resin layer (polyamide film) of the laminated composite material. And in the step D, the amorphous Si layer is irradiated with laser, and the display element, the optical element or the illumination element (including the polyamide resin layer) as a product is removed from the glass plate.

FIG. 4 shows one or plurality of none-limiting embodiments in which an inorganic layer is formed on one surface of the polyamide resin layer, wherein the surface is not opposed to the glass plate. The inorganic layer in the embodiments may be, for example, an inorganic barrier layer. In the step A, polyamide varnish is applied onto the glass plate, dried and/or cured in the step B to form the laminated composite material. At this time, the inorganic layer is further formed in the polyamide resin layer (polyamide film) step C. In one or plurality of none-limiting embodiments, the laminated composite material of this disclosure may include the inorganic layer (FIG. 4, step C). A display element, an optical element, or an illumination element is formed on the inorganic layer. In the step D, the polyamide resin layer is removed, and the display element, the optical element or the illumination element (including the polyamide resin layer) as a product is obtained.

[Polyamide Resin Layer]

Regarding the polyamide resin of the polyamide resin layer of the laminated composite material according to this disclosure, the rate of mass change of the polyamide resin from 300° C. to 400° C. measured by thermo gravimetry (TG) is 3.0% or less, 2.0% or less, 1.5% or less, or 1.0% or less in one or plurality of embodiments in terms of suppression of curvature deformation and/or enhancement of dimension stability of the laminated composite material. In one or plurality of embodiments, the rate of mass change from 300° C. to 400° C. measured by thermo gravimetry (TG) can be measured by a method described in Examples.

In one or plurality of embodiments, the polyamide resin of the polyamide resin layer of the laminated composite material according to this disclosure has a glass transition temperature of 300° C. or more, 320° C. or more, 330° C. or more, or 350° C. or more in terms of suppression of curvature deformation and/or enhancement of dimension stability of the laminated composite material. Further, in one or plurality of none-limiting embodiments, the polyamide resin has a glass transition temperature of 550° C. or less, 530° C. or less, or 500° C. or less. In one or plurality of embodiments, the glass transition temperature can be measured by a method described in Examples.

In one or plurality of embodiments, the polyamide resin of the polyamide resin layer of the laminated composite material according to this disclosure satisfies both the condition regarding the rate of mass change from 300° C. to 400° C. measured by thermo gravimetry (TG) and the condition regarding the glass transition temperature in terms of suppression of curvature deformation and/or enhancement of dimension stability of the laminated composite material.

[Curvature Deformation]

The term “curvature deformation of the laminated composite material” as used herein refers to a difference between the maximum height and the minimum height of the laminated composite material measured with a laser displacement gauge. In one or plurality of embodiments, it is measured by a method described in Examples. In one or plurality of embodiments, the curvature deformation of the laminated composite material according to this disclosure is 500 μm or less or 250 μm or less. Similarly, in one or plurality of embodiments, the curvature deformation is −500 μm or more or −250 μm or more. It should be noted that the value of curvature deformation of the laminated composite material being positive means that the center of the laminated composite material is larger in height than the periphery, and the value of curvature deformation of the laminated composite material being negative means that the periphery of the laminated composite material is larger in height than the center.

[Thickness of Polyamide Resin Layer]

In one or plurality of embodiments, the polyamide resin layer of the laminated composite material according to this disclosure has a thickness of 500 μm or less, 200 μm or less, or 100 μm or less in terms of suppression of curvature deformation and/or enhancement of dimension stability of the laminated composite material, as well as suppression of the development of cracks in the resin layer. Further, in one or plurality of none-limiting embodiments, the polyamide resin layer has a thickness of 1 μm or more, 2 μm, or 3 μm or more.

[Transmittance of Polyamide Resin Layer]

In one or plurality of embodiments, the polyamide resin layer of the laminated composite material according to this disclosure has a total light transmittance of 70% or more, 75% or more, or 80% or more in terms of allowing the laminated composite material to be used suitably in the production of a display element, an optical element, or an illumination element.

[Glass Plate]

In one or plurality of embodiments, the material of the glass plate of the laminated composite material according to this disclosure may be, for example, soda-lime glass, none-alkali glass or the like in terms of suppression of curvature deformation and/or enhancement of dimension stability of the laminated composite material. In particular, soda-lime glass is preferable in terms of suppression of curvature deformation and/or enhancement of dimension stability of the laminated composite material.

In terms of suppression of curvature deformation and/or enhancement of dimension stability of the laminated composite material, the glass plate of the laminated composite material according this disclosure has a thickness of 0.3 mm or more, 0.4 mm or more, or 0.5 mm or more. Further, in one or plurality of embodiments, the glass plate has a thickness of 3 mm or less or 1 mm or less.

[Solution of Polyamide]

In one or plurality of embodiments, the polyamide resin layer of the laminated composite material according to this disclosure can be manufactured by choosing as appropriate a solution or varnish of the below-disclosed polyamide from which a polyamide resin satisfying the condition regarding the rate of mass change from 300° C. to 400° C. measured by thermo gravimetry (TG) and/or the glass transition temperature can be obtained.

Therefore, one aspect of this disclosure relates to a solution of polyamide for use in manufacturing the laminated composite material, and the solution includes an aromatic polyamide and a solvent.

In one or plurality of embodiments, the solution of polyamide according to this disclosure may be one with a reduced amount of low molecular weight components in terms of suppression of curvature deformation and/or enhancement of dimension stability of the laminated composite material. Similarly, in one or plurality of embodiments, low molecular weight components having a molecular weight of 1000 or less are not detected or detected only in trace amounts from the solution of polyamide by gel permeation chromatography (GPC). In one or plurality of embodiments, being detected only in trance amounts means that the low molecular weight components having a molecular weight of 1000 or less measured by GPC is 0.2% by area.

In one or plurality of embodiments, the solution of polyamide according to this disclosure may be one obtained by synthesizing a polyamide and precipitating the resulting polyamide in terms of suppression of curvature deformation and/or enhancement of dimension stability of the laminated composite material. The precipitation can be carried out by a typical method. In one or plurality of embodiments, by adding the polyamide to methanol, ethanol, isopropyl alcohol or the like, it is precipitated, cleaned, and dissolved in the solvent, for example.

In terms of suppression of curvature deformation and/or enhancement of dimension stability of the laminated composite material, at least one end of the polyamide of the solution of polyamide according to this disclosure is end-capped.

With regard to the solution of polyamide according to this disclosure, monomers for use in synthesizing the polyamide may include a carboxyl group-containing diamine monomer in one or plurality of embodiments in terms of suppression of curvature deformation and/or enhancement of dimension stability of the laminated composite material. In this case, in one or plurality of embodiments, the amount of the carboxyl group-containing diamine monomer may be 30 mol % or less, 20 mol % or less, or 1 to 10 mol % with respect to the total amount of the monomers.

In terms of suppression of curvature deformation and/or enhancement of dimension stability of the laminated composite material, the solution of polyamide according to this disclosure may be, in one or plurality of embodiments, a solution of polyamide including a solvent and an aromatic polyamide having repeat units represented by the following general formulae (I) and (II).

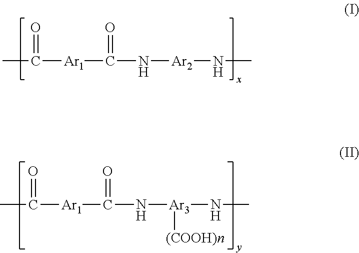

wherein x represents mole % of the repeat structure (I), y represents mole % of the repeat structure (II), x varies from 90 to 100, and y varies from 10 to 0;

wherein n=1 to 4;

wherein Ar₁ is selected from the group comprising:

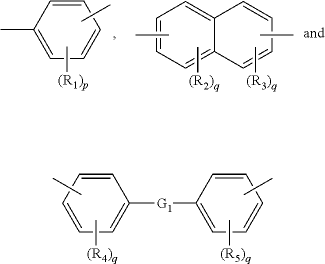

wherein p=4, q=3, and wherein R₁, R₂, R₃, R₄, R₅ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as halogenated alkoxy, aryl, or substituted aryl such as halogenated aryls, alkyl ester and substituted alkyl esters, and combinations thereof. It is to be understood that each R₁ can be different, each R₂ can be different, each R₃ can be different, each R₄ can be different, and each R₅ can be different. G₁ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si (CH₃)₂ group; 9,9-fluorene group; substituted 9,9-fluorene; and an OZO group, wherein Z is a aryl group or substituted aryl group, such as phenyl group, biphenyl group, perfluorobiphenyl group, 9,9-bisphenylfluorene group, and substituted 9,9-bisphenylfluorene;

wherein Ar₂ is selected from the group of comprising:

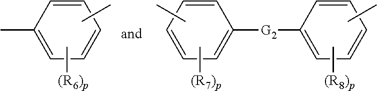

wherein p=4, wherein R₆, R₇, R₈ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as halogenated alkoxy, aryl, substituted aryl such as halogenated aryls, alkyl ester, and substituted alkyl esters, and combinations thereof. It is to be understood that each R₅ can be different, each R₇ can be different, and each % can be different. G₂ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si (CH₃)₂ group; 9,9-fluorene group; substituted 9,9-fluorene; and an OZO group, wherein Z is a aryl group or substituted aryl group, such as phenyl group, biphenyl group, perfluorobiphenyl group, 9,9-bisphenylfluorene group, and substituted 9,9-bisphenylflorene;

wherein Ar₃ is selected from the group comprising:

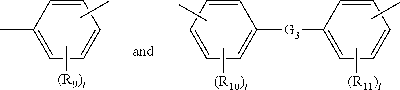

wherein t=2 or 3, wherein R₉, R₁₀, R₁₁ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as halogenated alkoxy, aryl, substituted aryl such as halogenated aryls, alkyl ester, and substituted alkyl esters, and combinations thereof. It is to be understood that each R₉ can be different, each R₁₀ can be different, and each R₁₁ can be different. G₃ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si (CH₃)₂ group; 9,9-fluorene group; substituted 9,9-fluorene; and an OZO group, wherein Z is a aryl group or substituted aryl group, such as phenyl group, biphenyl group, perfluorobiphenyl group, 9,9-bisphenylfluorene group, and substituted 9,9-bisphenylfluorene.

In one or plurality of embodiments of this disclosure, (I) and (II) are selected so that the polyamide is soluble in a polar solvent or a mixed solvent comprising one or more polar solvents. In one or plurality of embodiments of this disclosure, x varies from 90 to 100 mole % of the repeat structure (I), and y varies from 10 to 0 mole % of the repeat structure (II). In one or plurality of embodiments of this disclosure, the aromatic polyamide contains multiple repeat units with the structures (I) and (II) where Ar₁, Ar₂, and Ar₃ are the same or different.

In terms of suppression of curvature deformation and/or enhancement of dimension stability of the laminated composite material, the solution of polyamide according to this disclosure is, in one or plurality of embodiments, one that is obtained or can be obtained by a manufacturing process including the following steps:

a) dissolving at least one aromatic diamine in a solvent;

b) reacting the at least one aromatic diamine mixture with at least one aromatic diacid dichloride, wherein hydrochloric acid and a polyamide solution is generated;

c) removing the free hydrochloric acid by reaction with a trapping reagent;

d) optionally re-precipitating resulting polyamide.

In one or more embodiments of the process for manufacturing a polyamide solution of this disclosure, the aromatic diacid dichloride includes those shown in the following general structures:

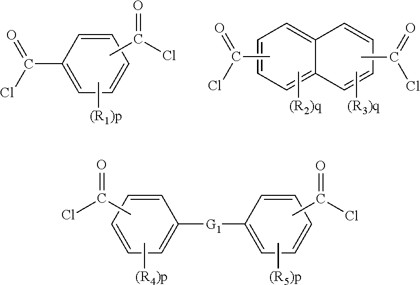

wherein p=4, q=3, and wherein R₁, R₂, R₃, R₄, R₅ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as a halogenated alkoxy, aryl, or substituted aryl such as halogenated aryls, alkyl ester and substituted alkyl esters, and combinations thereof. It is to be understood that each R₁ can be different, each R₂ can be different, each R₃ can be different, each R₄ can be different, and each R₅ can be different. G₁ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si (CH₃)₂ group; 9,9-fluorene group; substituted 9,9-fluorene; and an OZO group, wherein Z is a aryl group or substituted aryl group, such as phenyl group, biphenyl group, perfluorobiphenyl group, 9,9-bisphenylfluorene group, and substituted 9,9-bisphenylfluorene.

In terms of suppression of curvature deformation and/or enhancement of dimension stability of the laminated composite material, aromatic dicarboxylic acid dichloride used in the process for manufacturing the solution of polyamide of this disclosure may be, in one or more embodiments, the following:

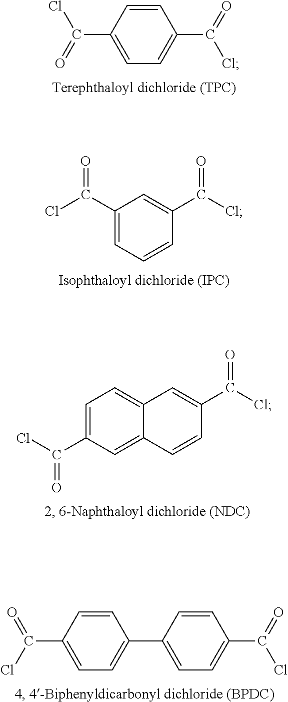 [SMILES: O=C(Cl)c1ccc(C(=O)Cl)cc1 ; O=C(Cl)c1cccc(C(=O)Cl)c1 ; O=C(Cl)c1ccc2cc(C(=O)Cl)ccc2c1 ; O=C(Cl)c1ccc(-c2ccc(C(=O)Cl)cc2)cc1]

In one or more embodiments of the process for manufacturing a polyamide solution of this disclosure, the aromatic diamine includes those shown in the following general structures:

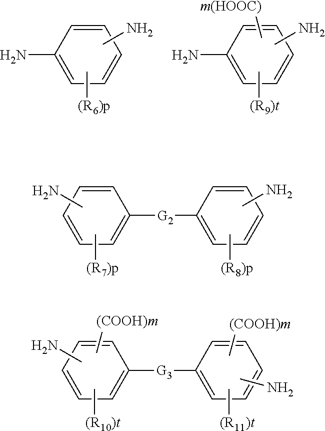

wherein p=4, m=1 or 2, and t=1 to 3, wherein R₆, R₇, R₈, R₉, R₁₀, R₁₁ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as a halogenated alkoxy, aryl, substituted aryl such as halogenated aryls, alkyl ester, and substituted alkyl esters, and combinations thereof. It is to be understood that each R₆ can be different, each R₇ can be different, each R₈ can be different, each R₉ can be different, each R₁₀ can be different, and each R₁₁ can be different. G₂ and G₃ are selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si (CH₃)₂ group; 9,9-fluorene group; substituted 9,9-fluorene; and an OZO group, wherein Z is a aryl group or substituted aryl group, such as phenyl group, biphenyl group, perfluorobiphenyl group, 9,9-bisphenylfluorene group, and substituted 9,9-bisphenylfluorene.

In terms of suppression of curvature deformation and/or enhancement of dimension stability of the laminated composite material, the aromatic diamine used in the process for manufacturing the solution of polyamide of this disclosure may be, in one or more embodiments, the following:

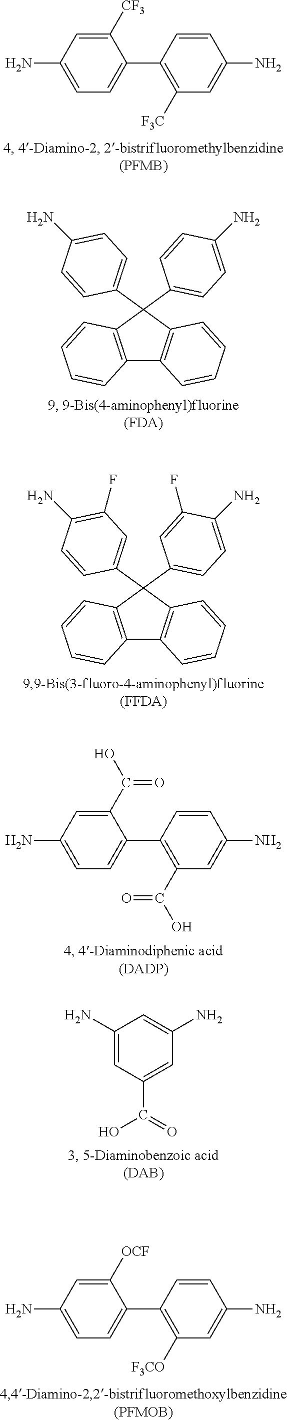

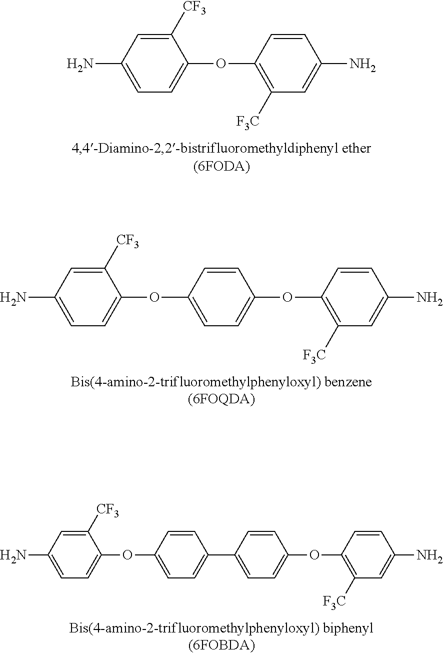 [SMILES: Nc1ccc(Oc2ccc(N)cc2C(F)(F)F)c(C(F)(F)F)c1 ; Nc1ccc(Oc2ccc(Oc3ccc(N)cc3C(F)(F)F)cc2)c(C(F)(F)F)c1 ; Nc1ccc(Oc2ccc(-c3ccc(Oc4ccc(N)cc4C(F)(F)F)cc3)cc2)c(C(F)(F)F)c1]

In one or more embodiments of the process for manufacturing a polyamide solution of this disclosure, a polyamide is prepared via a condensation polymerization in a solvent, where the hydrochloric acid generated in the reaction is trapped by a reagent like propylene oxide (PrO).

In one or plurality of embodiments of this disclosure, in terms of enhancement of solubility of the polyamide to the solvent, the solvent is a polar solvent or a mixed solvent comprising one or more polar solvents. In one or plurality of embodiments of this disclosure, in terms of enhancement of solubility of the polyamide to the solvent and enhancement of the adhesion between polyamide film and the base, the solvent is cresol, N,N-dimethylacetamide (DMAc), N-methyl-2-pyrrolidinone (NMP), dimethylsulfoxide (DMSO), butyl cellosolve, or a mixed solvent comprising at least one of cresol, N,N-dimethylacetamide (DMAc), N-methyl-2-pyrrolidinone (NMP), dimethylsulfoxide (DMSO), 1,3-dimethyl-imidazolidinone (DMI), or butyl cellosolve, a combination thereof, or a mixed solvent comprising at least one of polar solvent thereof.

In one or plurality of embodiments of this disclosure, in terms of suppression of curvature deformation and/or enhancement of dimension stability, one of the diamine is 4,4′-diaminodiphenic acid or 3,5-diaminobenzoic acid.

In one or plurality of embodiments of this disclosure, in terms of suppression of curvature deformation and/or enhancement of dimension stability, the reaction of hydrochloric acid with the trapping reagent yields a volatile product.

In one or plurality of embodiments of this disclosure, in terms of suppression of curvature deformation and/or enhancement of dimension stability, the trapping reagent is propylene oxide. In one or plurality of embodiments of this disclosure, the trapping reagent is added to the mixture before or during the reacting step (b). Adding the reagent before or during the reaction step (b) can reduce degree of viscosity and generation of lumps in the mixture after the reaction step (b), and therefore, can improve productivity of the solution of the polyamide. These effects are significant specifically when the reagent is organic reagent, such as propylene oxide.

In one or plurality of embodiments of this disclosure, in terms of enhancement of heat resistance property of the polyamide film, the process further comprises the step of end-capping of one or both of terminal —COOH group and terminal —NH₂ group of the polyamide.

In one or plurality of embodiments of this disclosure, in terms of suppression of curvature deformation and/or enhancement of dimension stability, the polyamide is first isolated from the polyamide solution by precipitation and redissolved in a solvent.

In one or plurality of embodiments of this disclosure, in terms of suppression of curvature deformation and/or enhancement of dimension stability, the solution is produced in the absence of inorganic salt.

[Process for Manufacturing Laminated Composite Material]

The laminated composite material of this disclosure can be manufactured by applying the above-described solution of polyamide onto a glass plate, drying the applied solution, and if necessary, curing the applied solution.

In one or plurality of embodiments of this disclosure, a process for manufacturing the laminated composite material of this disclosure includes the steps of.

a) applying a solution of an aromatic polyamide onto a base; and

b) heating the casted polyamide solution to form a polyamide film after the applying step (a).

In one or plurality of embodiments of this disclosure, in terms of suppression of curvature deformation and/or enhancement of dimension stability, the heating is carried out under the temperature ranging from approximately +40° C. of the boiling point of the solvent to approximately +100° C. of the boiling point of the solvent, preferably from approximately +60° C. of the boiling point of the solvent to approximately +80° C. of the boiling point of the solvent, more preferably approximately +70° C. of the boiling point of the solvent. In one or plurality of embodiments of this disclosure, in terms of suppression of curvature deformation and/or enhancement of dimension stability, the temperature of the heating in step (b) is between approximately 200° C. and approximately 250° C. In one or plurality of embodiments of this disclosure, in terms of suppression of curvature deformation and/or enhancement of dimension stability, the time of the heating is more than approximately 1 minute and less than approximately 30 minutes.

The process for manufacturing the laminated composite material may include, following the step (b), a curing step (c) in which the polyamide film is cured. The curing temperature depends upon the capability of a heating device but is 220° C. to 420° C., 280 to 400° C., or 330° C. to 370° C. in one or plurality of embodiments.

[Process for Manufacturing Display Element, Optical Element or Illumination Element]

One aspect of this disclosure relates to a process for manufacturing a display element, an optical element, or an illumination element, which includes the step of forming the display element, the optical element or the illumination element on a surface of the organic resin layer of the laminated composite material of this disclosure, wherein the surface is not opposed to the glass plate.

[Display Element, Optical Element, or Illumination Element]

The term “a display element, an optical element, or an illumination element” as used herein refers to an element that constitutes a display (display device), an optical device, or an illumination device, and examples of such elements include an organic EL element, a liquid crystal element, and organic EL illumination. Further, the term also covers a component of such elements, such as a thin film transistor (TFT) element, a color filter element or the like. In one or more embodiments, the display element, the optical element or the illumination element according to the present disclosure may include the polyamide film according to the present disclosure, may be produced using the solution of polyamide according to the present disclosure, or may use the polyamide film according to the present disclosure as the substrate of the display element, the optical element or the illumination element.

<Non-Limiting Embodiment of Organic EL Element>

Hereinafter, one embodiment of an organic EL element as one embodiment of the display element according to the present disclosure will be described with reference to the drawing.

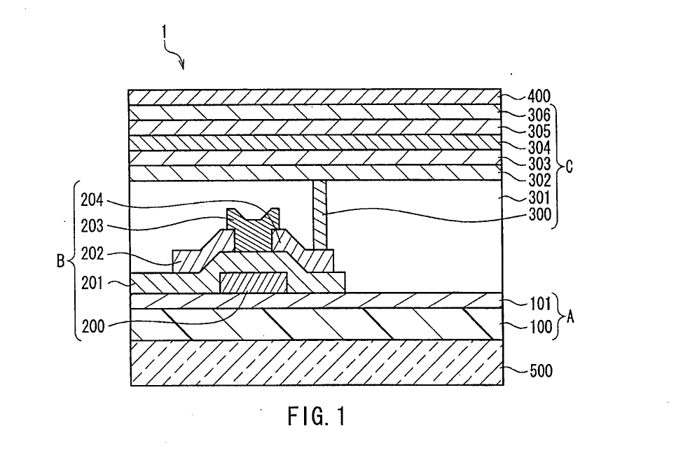

FIG. 1 is a schematic cross-sectional view showing an organic EL element 1 according to one embodiment. The organic EL element 1 includes a thin film transistor B formed on a substrate A and an organic EL layer C. Note that the organic EL element 1 is entirely covered with a sealing member 400. The organic EL element 1 may be separate from a base 500 or may include the base 500. Hereinafter, each component will be described in detail.

1. Substrate A

The substrate A includes a transparent resin substrate 100 and a gas barrier layer 101 formed on top of the transparent resin substrate 100. Here, the transparent resin substrate 100 is the polyamide film according to the present disclosure.

The transparent resin substrate 100 may have been annealed by heat. Annealing is effective in, for example, removing distortions and in improving the size stability against environmental changes.

The gas barrier layer 101 is a thin film made of SiOx, SiNx or the like, and is formed by a vacuum deposition method such as sputtering, CVD, vacuum deposition or the like. Generally, the gas barrier layer 101 has a thickness of, but is not limited to, about 10 nm to 100 nm. Here, the gas barrier layer 101 may be formed on the side of the transparent resin substrate 100 facing the gas barrier layer 101 in FIG. 1 or may be formed on the both sides of the transparent resin substrate 100.

2. Thin Film Transistor

The thin film transistor B includes a gate electrode 200, a gate insulating layer 201, a source electrode 202, an active layer 203, and a drain electrode 204. The thin film transistor B is formed on the gas barrier layer 101.

The gate electrode 200, the source electrode 202, and the drain electrode 204 are transparent thin films made of indium tin oxide (ITO), indium zinc oxide (IZO), zinc oxide (ZnO), or the like. For example, sputtering, vapor deposition, ion platting or the like may be use to form these transparent thin films. Generally, these electrodes have a film thickness of, but is not limited to, about 50 nm to 200 nm.

The gate insulating film 201 is a transparent insulating thin film made of SiO₂, Al₂O₃ or the like, and is formed by sputtering, CVD, vacuum deposition, ion plating or the like. Generally, the gate insulating film 201 has a film thickness of, but is not limited to, about 10 nm to 1 μm.

The active layer 203 is a layer of, for example, single crystal silicon, low temperature polysilicon, amorphous silicon, or oxide semiconductor, and a material best suited to the active layer 203 is used as appropriate. The active layer is formed by sputtering or the like.

3. Organic EL Layer

The organic EL layer C includes a conductive connector 300, an insulative flattened layer 301, a lower electrode 302 as the anode of the organic EL element A, a hole transport layer 303, a light-emitting layer 304, an electron transport layer 305, and an upper electrode 306 as the cathode of the organic EL element A. The organic EL layer C is formed at least on the gas barrier layer 101 or on the thin film transistor B, and the lower electrode 302 and the drain electrode 204 of the thin film transistor B are connected to each other electrically through the connector 300. Instead, the lower electrode 302 of the thin film transistor B and the source electrode 202 may be connected to each other through the connector 300.

The lower electrode 302 is the anode of the organic EL element 1a, and is a transparent thin film made of indium tin oxide (ITO), indium zinc oxide (IZO), zinc oxide (ZnO) or the like. ITO is preferred because, for example, high transparency, and high conductivity can be achieved.

For the hole transport layer 303, the light-emitting layer 304, and the electron transport layer 305, conventionally-known materials for organic EL elements can be used as is.

The upper electrode 305 is a film composed of a layer of lithium fluoride (T having a film thickness of 5 nm to 20 nm and a layer of aluminum (Al) having a film thickness of 50 nm to 200 nm. For example, vapor deposition may be use to form the film.

When producing a bottom emission type organic EL element, the upper electrode 306 of the organic EL element 1a may be configured to have optical reflectivity. Thereby, the upper electrode 306 can reflect in the display side direction light generated by the organic EL element A and traveled toward the upper side as the opposite direction to the display side. Since the reflected light is also utilized for a display purpose, the emission efficiency of the organic EL element can be improved.

[Method of Producing Display Element, Optical Element, or Illumination Element]

Another aspect of the present disclosure relates to a method of producing a display element, an optical element, or an illumination element. In one or more embodiments, the production method according to the present disclosure is a method of producing the display element, the optical element, or the illumination element according to the present disclosure. Further, in one or more embodiments, the production method according to the present disclosure is a method of producing a display element, an optical element, or an illumination element, which includes the steps of applying the polyamide resin composition according to the present disclosure onto a base; forming a polyamide film after the application step; and forming the display element, the optical element, or the illumination element on the side of the base not in contact with the polyamide resin film. The production method according to the present disclosure may further include the step of de-bonding, from the base, the display element, the optical element, or the illumination element formed on the base.

<Non-Limiting Embodiment of Method of Producing Organic EL Element>

As one embodiment of the method of producing a display element according to the present disclosure, hereinafter, one embodiment of a method of producing an organic EL element will be described with reference to the drawing.

A method of producing the organic EL element 1 shown in FIG. 1 includes a fixing step, a gas barrier layer preparation step, a thin film transistor preparation step, an organic EL layer preparation step, a sealing step and a de-bonding step. Hereinafter, each step will be described in detail.

1. Fixing Step

In the fixing step, the transparent resin substrate 100 is fixed onto the base 500. A way to fix the transparent resin substrate 100 to the base 500 is not particularly limited. For example, an adhesive may be applied between the base 500 and the transparent substrate or a part of the transparent resin substrate 100 may be fused and attached to the base 500 to fix the transparent resin substrate 100 to the base 500. Further, as the material of the base, glass, metal, silicon, resin or the like is used, for example. These materials may be used alone or in combination of two or more as appropriate. Furthermore, the transparent resin substrate 100 may be attached to the base 500 by applying a releasing agent or the like to the base 500 and placing the transparent resin substrate 100 on the applied releasing agent. In one or more embodiments, the polyamide film 100 is formed by applying the polyamide resin composition according to the present disclosure to the base 500, and drying the applied polyamide resin composition.

2. Gas Barrier Layer Preparation Step

In the gas barrier layer preparation step, the gas barrier layer 101 is prepared on the transparent resin substrate 100. A way to prepare the gas barrier layer 101 is not particularly limited, and a known method can be used.

3. Thin Film Transistor Preparation Step

In the thin film transistor preparation step, the thin film transistor B is prepared on the gas barrier layer. A way to prepare the thin film transistor B is not particularly limited, and a known method can be used.

4. Organic EL Layer Preparation Step

The organic EL layer preparation step includes a first step and a second step. In the first step, the flattened layer 301 is formed. The flattened layer 301 can be formed by, for example, spin-coating, slit-coating, or ink-jetting a photosensitive transparent resin. At that time, an opening needs to be formed in the flattened layer 301 so that the connector 300 can be formed in the second step. Generally, the flattened layer has a film thickness of but is not limited to, about 100 nm to 2 μm.

In the second step, first, the connector 300 and the lower electrode 302 are formed at the same time. Sputtering, vapor deposition, ion platting or the like may be used to form the connector 300 and the lower electrode 302. Generally, these electrodes have a film thickness of, but is not limited to, about 50 nm to 200 nm. Subsequently, the hole transport layer 303, the light-emitting layer 304, the electron transport layer 305, and the upper electrode 306 as the cathode of the organic EL element A are formed. To form these components, a method such as vapor deposition, application, or the like can be used as appropriate in accordance with the materials to be used and the laminate structure. Further, irrespective of the explanations given in this example, other layers may be chosen from known organic layers such as a hole injection layer, an electron transport layer, a hole blocking layer and an electron blocking layer as needed and be used to configuring the organic layers of the organic EL element A.

5. Sealing Step

In the sealing step, the organic EL layer A is sealed with the sealing member 400 from top of the upper electrode 306. For example, a glass material, a resin material, a ceramics material, a metal material, a metal compound or a composite thereof can be used to form the sealing member 400, and a material best suited to the sealing member 400 can be chosen as appropriate.

6. De-Bonding Step

In the de-bonding step, the organic EL element 1 prepared is stripped from the base 500. To implement the de-bonding step, for example, the organic EL element 1 may be physically stripped from the base 500. At that time, the base 500 may be provided with a de-bonding layer, or a wire may be inserted between the base 500 and the display element to remove the organic EL element. Further, examples of other methods of de-bonding the organic EL element 1 from the base 500 include the following: forming a de-bonding layer on the base 500 except at ends, and cutting, after the preparation of the element, the inner part from the ends to remove the element from the base; providing a layer of silicon or the like between the base 500 and the element, and irradiating the silicon layer with a laser to strip the element; applying heat to the base 500 to separate the base 500 and the transparent substrate from each other; and removing the base 500 using a solvent. These methods may be used alone or any of these methods may be used in combination of two or more. Especially in one or more embodiments, the strength of adhesion between PA film and the Base can be controlled by silane coupling agent, so that the organic EL element 1 may be physically stripped without using the complicated process such as described above.

In one or more embodiments, the organic EL element obtained by the method of producing a display, optical or illumination element according to the present embodiment has excellent characteristics such as excellent transparency and heat-resistance, low linear expansivity and low optical anisotropy.

[Display Device, Optical Device, and Illumination Device]

Another aspect of the present disclosure relates to a display device, an optical device, or an illumination device using the display element, the optical element, or the illumination element according to the present disclosure, or a method of producing the display device, the optical device, or the illumination device. Examples of the display device include, but are not limited to, an imaging element, examples of the optical device include, but are not limited to, a photoelectric complex circuit, and examples of the illumination device include, but are not limited to, a TFT-LCD and OEL illumination.

### EXAMPLES

Polyamide solutions (Solution 1 to 5) were prepared using components as described in Table 1 as well as bellow.

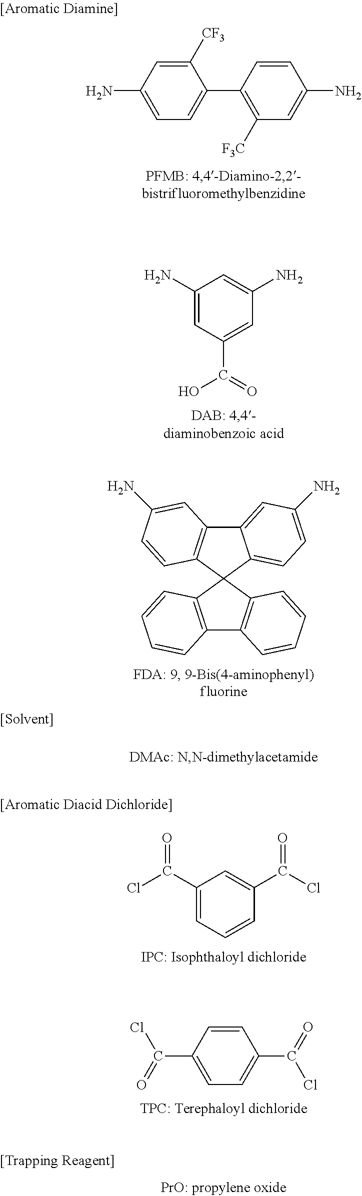 [SMILES: Nc1ccc(-c2ccc(N)cc2C(F)(F)F)c(C(F)(F)F)c1 ; Nc1cc(N)cc(C(=O)O)c1 ; Nc1ccc2c(c1)-c1cc(N)ccc1C21c2ccccc2-c2ccccc21 ; O=C(Cl)c1cccc(C(=O)Cl)c1 ; O=C(Cl)c1ccc(C(=O)Cl)cc1]

This example illustrates the general procedure for the preparation of Solution 1 containing 5 weight % of a copolymer of TPC, IPC, DAB, and PFMB (70%/30%/5%/95% mol ratio) in DMAc. This procedure includes a step of precipitation of a synthesized polymer after a polymerizing step.

To a 250 ml three necked round bottom flask, equipped with a mechanical stirrer, a nitrogen inlet and outlet, are added PFMB (3.042 g, 0.0095 mol), DAB (0.0761 g, 0.0005 mol) and DMAc (45 ml) After the PFMB and DAB dissolved completely, PrO (1.4 g, 0.024 mol) was added to the solution. The solution is cooled to 0° C. Under stirring, IPC (0.5989 g, 0.00295 mol) was added to the solution, and the flask wall was washed with DMAc (1.5 ml). After 15 minutes, TPC (1.4110 g, 0.00695 mol) was added to the solution and the flask wall was again washed with DMAc (1.5 ml). After two hours, benzoyl chloride (0.032 g, 0.23 mmol) was added to the solution and stirred for another two hours. The solution which is described above was added in the 500 ml of methanol and stirred. Polymer which was deposited in the methanol described above was further put in the 150 ml of methanol and washed for 10 minutes, two times. After that, the polymer was put in the 150 ml of pure water and washed for 10 minutes, two times. After that, the polymer was dehydrated and dried. Dried polymer was dissolved with DMAc (60 ml) to obtain Solution 1.

This example illustrates the general procedure for the preparation of Solution 2 containing 5 weight % of a copolymer of IPC, DAB, and PFMB (100%/5%/95% mol ratio) in DMAc. This procedure includes a step of precipitation of a synthesized polymer after a polymerizing step.

To a 250 ml three necked round bottom flask, equipped with a mechanical stirrer, a nitrogen inlet and outlet, are added PFMB (3.042 g, 0.0095 mol), DAB (0.0761 g, 0.0005 mol) and DMAc (45 ml). After the PFMB and DAB dissolved completely, PrO (1.4 g, 0.024 mol) was added to the solution. The solution is cooled to 0° C. Under stirring, IPC (2.01 g, 0.0099 mol) was added to the solution, and the flask wall was washed with DMAc (1.5 ml). After two hours, benzoyl chloride (0.032 g, 0.23 mmol) was added to the solution and stirred for another two hours. The solution which is described above was added in the 500 ml of methanol and stirred. Polymer which was deposited in the methanol described above was further put in the 150 ml of methanol and washed for 10 minutes, two times. After that, the polymer was put in the 150 ml of pure water and washed for 10 minutes, two times. After that, the polymer was dehydrated and dried. Dried polymer was solved in the solution of DMAc (60 ml).

This example illustrates the general procedure for the preparation of Solution 3 containing 5 weight % a copolymer of IPC, DAB, PFMB and FDA (100%/5%/50%/45% mol ratio) in DMAc. This procedure includes a step of precipitation of a synthesized polymer after a polymerizing step.

To a 250 ml three necked round bottom flask, equipped with a mechanical stirrer, a nitrogen inlet and outlet, are added PFMB (1.601 g, 0.005 mol), DAB (0.0761 g, 0.0005 mol) FDA (1.743 g, 0.005 mol) and DMAc (45 ml). After the PFMB, DAB and FDA dissolved completely, PrO (1.4 g, 0.024 mol) was added to the solution. The solution is cooled to 0° C. Under stirring, IPC (2.01 g, 0.0099 mol) was added to the solution, and the flask wall was washed with DMAc (1.5 ml). After two hours, benzoyl chloride (0.032 g, 0.23 mmol) was added to the solution and stirred for another two hours. The solution which is described above was added in the 500 ml of methanol and stirred. Polymer which was deposited in the methanol described above was further put in the 150 ml of methanol and washed for 10 minutes, two times. After that, the polymer was put in the 150 ml of pure water and washed for 10 minutes, two times. After that, the polymer was dehydrated and dried. Dried polymer was solved in the solution of DMAc (60 ml)).

This example illustrates the general procedure for the preparation of Solution 4 containing 5 weight % a copolymer of TPC, IPC, DAB, PFMB (70%/30%/60%/40% mol ratio) in DMAc. This procedure includes a step of precipitation of a synthesized polymer after a polymerizing step.

To a 250 ml three necked round bottom flask, equipped with a mechanical stirrer, a nitrogen inlet and outlet are added PFMB (1.281 g, 0.0040 mol), DAB (0.9132 g, 0.0060 mol) and DMAc (45 ml). After the PFMB, DAB and FDA dissolved completely, PrO (1.4 g, 0.024 mol) was added to the solution. The solution is cooled to 0° C. Under stirring, IPC (0.5989 g, 0.00295 mol) was added to the solution, and the flask wall was washed with DMAc (1.5 ml). After 15 minutes, TPC (1.4110 g, 0.00695 mol) was added to the solution and the flask wall was again washed with DMAc (1.5 ml). After two hours, benzoyl chloride (0.032 g, 0.23 mmol) was added to the solution and stirred for another two hours. The solution which is described above was added in the 500 ml of methanol and stirred. Polymer which was deposited in the methanol described above was further put in the 150 ml of methanol and washed for 10 minutes, two times. After that, the polymer was put in the 150 ml of pure water and washed for 10 minutes, two times. After that, the polymer was dehydrated and dried. Dried polymer was solved in the solution of DMAc (60 ml).

This example illustrates the general procedure for the preparation of Solution 5 containing 5 weight % a copolymer of TPC, IPC, DAB, PFMB (70%/30%/60%/40% mol ratio) in DMAc. This procedure does not include a step of precipitation of a synthesized polymer after a polymerizing step.

To a 250 ml three necked round bottom flask, equipped with a mechanical stirrer, a nitrogen inlet and outlet, are added PFMB (1.281 g, 0.0040 mol), DAB (0.9132 g, 0.0060 mol) and DMAc (45 ml). After the PFMB, DAB and FDA dissolved completely, PrO (1.4 g, 0.024 mol) was added to the solution. The solution is cooled to 0° C. Under stirring, IPC (0.5989 g, 0.00295 mol) was added to the solution, and the flask wall was washed with DMAc (1.5 ml). After 15 minutes, TPC (1.4110 g, 0.00695 mol) was added to the solution and the flask wall was again washed with DMAc (1.5 ml). After two hours, benzoyl chloride (0.032 g, 0.23 mmol) was added to the solution and stirred for another two hours.

Polyamide films are prepared by use of Solutions 1 to 5 on a surface of a glass base to obtain a laminated composite. Residual material in the polyamide solution, thermo gravimetry (TG) and glass transition temperature (Tg) of the polyamide film, and curvature deformation and dimension stability of the laminated composite were measured as described below. The results are shown in the Table 1.

[Formation of Laminated Composite]

The polymer solution can be used directly for the film casting after polymerization. For the preparation of small films in a batch process, the solution was applied on a flat glass plate by spin coating, EAGLE XG (Corning Inc., U.S.A.), 370 mm×470 mm, and thickness is 0.5 mm. After drying on the substrate, at 60° C. for at least 30 minutes, the film was cured by heating at from 60 to 330° C., and keep 330° C. for 30 min under vacuum or in an inert atmosphere. Thickness of films was greater than approximately 10 μm thick.

[Thermo Gravimetry (TG)]

For TG of the polyamide films as prepared above, each film was heated from 25° C. to 500° C. at a programming rate of 10° C./min using TG/DTA 6200, SII from Nano Technology Inc., and a decreasing rate in mass in a range of 300° C. to 400° C. was measured.

[Glass transition Temperature (Tg)]

For Tg, each dynamic viscoelasticity in a range of 25° C. to 400° C. was measured using a dynamic mechanical analyzer (RHEOVIBRON DDV-01FP from A&D Company Ltd.) in air at a programming rate of 5° C./min and a tension of 10 mN, and the maximum value of tan D measured was set as Tg.

[Curvature Deformation]

The curvature of a laminate of each polyamide film and glass was measured with a laser displacement gauge (KEYENCE, LT9010). The difference between the maximum height and the minimum height was set as the curvature.

[Change in Sample Length (Dimension Stability)]

A change in coefficient of thermal expansion (CTE) obtained by repeated measurement was measured as follows. The temperature of a sample was increased from 25° C. to 320° C. using a dynamic mechanical analyzer (TMA4030SA from Bruker AXS) at 10° C./min Thereafter, the temperature was held at 320° C. for 30 minutes, and then was cooled to 25° C. This procedure was repeated three times. Then, the difference between the sample length after the first measurement and the sample length after the third measurement (after the temperature was reduced) was calculated, and the difference calculated was set as the change in sample length.

TABLE 1

| | | | | | Properties of | | Properties of | |
|---|---|---|---|---|---|---|---|---|
| | | | | | polyamide | | laminated composite | |
| | Components | | | | resin | | Curvature | Change of |
| | | | Diacid | | TG | Tg | deformation | dimension |
| Table 1 | Diamine | Solvent | Dichloride | Reprecipitation | (%) | (° C.) | (μm) | (μm) |
| Solution 1 | PFMB/DAB | DMAc | IPC/TPC | + | <1% | 360 | <200 | 25 |
| | (95/5, molar ratio) | | (30/70 molar ratio) | | | | | |
| Solution 2 | PFMB/DAB | DMAc | IPC | + | <1% | 350 | <200 | 120 |
| | (95/5, molar ratio) | | | | | | | |
| Solution 3 | PFMB/DAB/FDA | DMAc | IPC | + | <1% | 370 | <200 | 20 |
| | (45/5/50, molar ratio) | | | | | | | |
| Solution 4 | PFMB/DAB | DMAc | IPC/TPC | + | >3% | 334 | >200 | >150 |
| | (40/60, molar ratio) | | (30/70, molar ratio) | | | | | |
| Solution 5 | PFMB/DAB | DMAc | IPC/TPC | − | >4% | 333 | >300 | >150 |
| | (40/60, molar ratio) | | (30/70, molar ratio) | | | | | |

As shown in Table 1, for the laminated composite materials prepared using Solutions 1 to 3, the rate of TG mass change of each polyamide resin was 1% or less, and Tg was 350 to 370° C., suggesting that the laminated composite materials had reduced curvature deformation and improved dimension stability as compared with the laminated composite materials prepared using Solutions 4 and 5. In particular, for the laminated composite materials prepared using Solutions 1 and 3, a change in sample length was smaller than in the case of the laminated composite material prepared using Solution 2.

In contrast, for the laminated composite materials prepared by using Solutions 4 and 5, the amount of decline in mass of the prepared film measured by TG was larger than those in the case of Solutions 1 to 3 and Tg was smaller than those in the case of Solutions 1 to 3. Consequently, the curvature increased and the dimension stability deteriorated. Although the causes are not certain, it is believed that Solutions 4, 5 had a large DAB content, and carboxylic groups of DAB were likely to be decomposed and volatilized when the temperature was increased. As a result, it is believed that the curvature increased. Further, for Solution 5, no precipitation was carried out. Thus, the curvature became much larger than that of the laminated composite material using Solution 4 due to the volatilization of residual low molecular weight components, and the dimension stability also deteriorated.

The embodiments have been described, hereinabove. It will be apparent to those skilled in the art that the above methods and apparatuses may incorporate changes and modifications without departing from the general scope of this disclosure. It is intended to include all such modifications and alterations insofar as they come within the scope of the appended claims or the equivalents thereof. Although the description above contains much specificity, this should not be construed as limiting the scope of the disclosure, but as merely providing illustrations of some of the embodiments of this disclosure. Various other embodiments and ramifications are possible within its scope.

Furthermore, notwithstanding that the numerical ranges and parameters setting forth the broad scope of the disclosure are approximations, the numerical values set forth in the specific examples are reported as precisely as possible. Any numerical value, however, inherently contain certain errors necessarily resulting from the standard deviation found in their respective testing measurements.

What is claimed is:

1. A laminated composite material, comprising a glass plate, and an organic resin layer;
wherein the organic resin layer is laminated to one surface of the glass plate;
wherein the organic resin is a polyamide resin;
wherein a rate of mass change of the polyamide resin from 300° C. to 400° C. measured by thermo gravimetry (TG) is 3.0% or less; and
wherein the glass transition temperature of the polyamide resin is 300° C. or more.

2. The laminated composite material according to claim 1, wherein the thickness of the glass plate is from 0.3 mm or more.

3. The laminated composite material according to claim 1, for use in the process for manufacturing a display element, an optical element or an illumination element, comprising the steps of:
forming the display element, the optical element or the illumination element on a surface of the organic resin layer, wherein the surface is not opposed to the glass plate.

4. The laminated composite material according to claim 1, wherein the thickness of the polyamide resin is 500 μm or less.

5. The laminated composite material according to claim 1, wherein the total light transmittance of the polyamide resin is 70% or more.

6. The laminated composite material according to claim 1, wherein the ratio of diamine components containing carboxyl group to the total amount of monomers used in the synthesis of the polyamide resin is 30 mol % or less.

7. The laminated composite material according to claim 1, wherein the polyamide resin is formed from an aromatic polyamide having repeat units of general formulas (I) and (II): 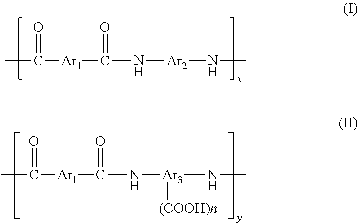
wherein x represents mole % of the repeat structure (I), y represents mole % of the repeat structure (II), x varies from 90 to 100, and y varies from 10 to 0;
wherein n=1 to 4;
wherein Ar₁ is selected from the group comprising: 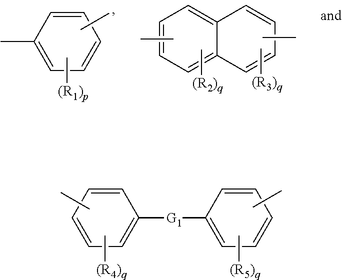
wherein p=4, q=3, and wherein R₂, R₃, R₄, R₅ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as halogenated alkoxy, aryl, or substituted aryl such as halogenated aryls, alkyl ester and substituted alkyl esters, and combinations thereof, wherein G₁ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si (CH₃)₂ group; 9,9-fluorene group; substituted 9,9-fluorene; and an OZO group, wherein Z is a aryl group or substituted aryl group, such as phenyl group, biphenyl group, perfluorobiphenyl group, 9,9-bisphenylfluorene group, and substituted 9,9-bisphenylfluorene;
wherein Ar² is selected from the group of comprising: 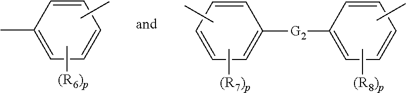
wherein p=4, wherein R₆, R₇, R₈ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as halogenated alkoxy, aryl, substituted aryl such as halogenated aryls, alkyl ester, and substituted alkyl esters, and combinations thereof, wherein G₂ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si (CH₃)₂ group; 9,9-fluorene group; substituted 9,9-fluorene; and an OZO group, wherein Z is a aryl group or substituted aryl group, such as phenyl group, biphenyl group, perfluorobiphenyl group, 9,9-bisphenylfluorene group, and substituted 9,9-bisphenylflorene;
wherein Ar₃ is selected from the group comprising: 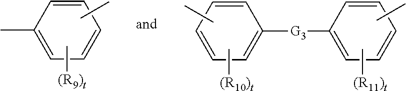
wherein t=2 or 3, wherein R₉, R₁₀, R₁₁ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as halogenated alkoxy, aryl, substituted aryl such as halogenated aryls, alkyl ester, and substituted alkyl esters, and combinations thereof, wherein G₃ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si (CH₃)₂ group; 9,9-fluorene group; substituted 9,9-fluorene; and an OZO group, wherein Z is a aryl group or substituted aryl group, such as phenyl group, biphenyl group, perfluorobiphenyl group, 9,9-bisphenylfluorene group, and substituted 9,9-bisphenylfluorene.

8. The laminated composite material according to claim 1, wherein the polyamide resin is formed from an aromatic polyamide produced by polymerizing at least one of aromatic diacid dichlorides selected from the group consisting of: 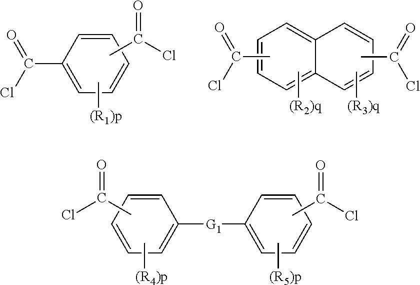
wherein p=4, q=3, and wherein R₁, R₂, R₃, R₄, R₅ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as a halogenated alkoxy, aryl, or substituted aryl such as halogenated aryls, alkyl ester and substituted alkyl esters, and combinations thereof. It is to be understood that each R₁ can be different, each R₂ can be different, each R₃ can be different, each R₄ can be different, and each R₅ can be different. G₁ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si (CH₃)₂ group; 9,9-fluorene group; substituted 9,9-fluorene; and an OZO group, wherein Z is a aryl group or substituted aryl group, such as phenyl group, biphenyl group, perfluorobiphenyl group, 9,9-bisphenylfluorene group, and substituted 9,9-bisphenylfluorene.

9. The laminated composite material according to claim 1, wherein the polyamide resin is formed from an aromatic polyamide produced by polymerizing at least one of aromatic diamines selected from the group consisting of: 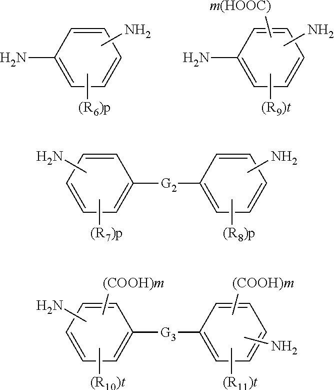
wherein p=4, m=1 or 2, and t=1 to 3, wherein R₆, R₇, R₈, R₉, R₁₀, R₁₁ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as a halogenated alkoxy, aryl, substituted aryl such as halogenated aryls, alkyl ester, and substituted alkyl esters, and combinations thereof. It is to be understood that each R₆ can be different, each R₇ can be different, each R₈ can be different, each R₉ can be different, each R₁₀ can be different, and each R₁₁ can be different. G₂ and G₃ are selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si (CH₃)₂ group; 9,9-fluorene group; substituted 9,9-fluorene; and an OZO group, wherein Z is a aryl group or substituted aryl group, such as phenyl group, biphenyl group, perfluorobiphenyl group, 9,9-bisphenylfluorene group, and substituted 9,9-bisphenylfluorene.

10. The laminated composite material according to claim 1, wherein the polyamide resin is formed from an aromatic polyamide, and wherein at least one of terminals of the aromatic polyamide is end-capped.

11. The laminated composite material according to claim 1, wherein the polyamide resin is formed through a heat treatment process, and wherein the temperature of the process is not less than 330° C.

12. The laminated composite material according to claim 1, wherein an amount of curvature of the laminated composite material measured by displacement sensor is −500 μm or more and 500 μm or less.

13. A solution of polyamide for use in a process for manufacturing the laminated composite material according to claim 1 comprising:
an aromatic polyamide and a solvent.

14. The solution according to claim 13, wherein the ratio of diamine components containing carboxyl group to the total amount of monomers used in the synthesis of the aromatic polyamide is 30 mol % or less.

15. The solution according to claim 13, wherein the aromatic polyamide comprises repeat units of general formulas (I) and (II): 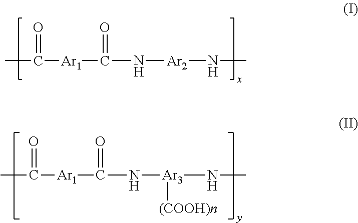
wherein x represents mole % of the repeat structure (I), y represents mole % of the repeat structure (II), x varies from 90 to 100, and y varies from 10 to 0;
wherein n=1 to 4;
wherein Ar₁ is selected from the group comprising: 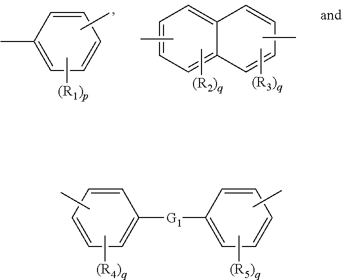
wherein p=4, q=3, and wherein R₁, R₂, R₃, R₄, R₅ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as halogenated alkoxy, aryl, or substituted aryl such as halogenated aryls, alkyl ester and substituted alkyl esters, and combinations thereof wherein G₁ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si (CH₃)₂ group; 9,9-fluorene group; substituted 9,9-fluorene; and an OZO group, wherein Z is a aryl group or substituted aryl group, such as phenyl group, biphenyl group, perfluorobiphenyl group, 9,9-bisphenylfluorene group, and substituted 9,9-bisphenylfluorene;
wherein Ar₂ is selected from the group of comprising: 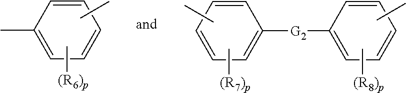
wherein p=4, wherein R₆, R₇, R₈ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as halogenated alkoxy, aryl, substituted aryl such as halogenated aryls, alkyl ester, and substituted alkyl esters, and combinations thereof wherein G₂ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si (CH₃)₂ group; 9,9-fluorene group; substituted 9,9-fluorene; and an OZO group, wherein Z is a aryl group or substituted aryl group, such as phenyl group, biphenyl group, perfluorobiphenyl group, 9,9-bisphenylfluorene group, and substituted 9,9-bisphenylflorene;
wherein Ar₃ is selected from the group comprising: 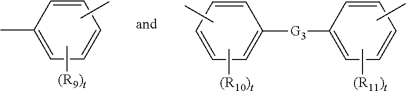
wherein t=2 or 3, wherein R₉, R₁₀, R₁₁ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as halogenated alkoxy, aryl, substituted aryl such as halogenated aryls, alkyl ester, and substituted alkyl esters, and combinations thereof, wherein G₃ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si (CH₃)₂ group; 9,9-fluorene group; substituted 9,9-fluorene; and an OZO group, wherein Z is a aryl group or substituted aryl group, such as phenyl group, biphenyl group, perfluorobiphenyl group, 9,9-bisphenylfluorene group, and substituted 9,9-bisphenylfluorene.

16. The solution according to claim 13, wherein the aromatic polyamide is produced by polymerizing at least one of aromatic diacid dichlorides selected from the group consisting of: 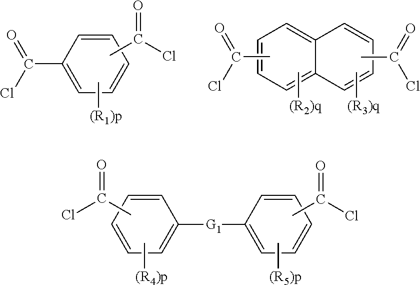
wherein p=4, q=3, and wherein R₁, R₂, R₃, R₄, R₅ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as a halogenated alkoxy, aryl, or substituted aryl such as halogenated aryls, alkyl ester and substituted alkyl esters, and combinations thereof. It is to be understood that each R₁ can be different, each R₂ can be different, each R₃ can be different, each R₄ can be different, and each R₅ can be different. G₁ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si (CH₃)₂ group; 9,9-fluorene group; substituted 9,9-fluorene; and an OZO group, wherein Z is a aryl group or substituted aryl group, such as phenyl group, biphenyl group, perfluorobiphenyl group, 9,9-bisphenylfluorene group, and substituted 9,9-bisphenylfluorene.

17. The solution according to claim 13, wherein the aromatic polyamide is produced by polymerizing at least one of aromatic diamines selected from the group consisting of: 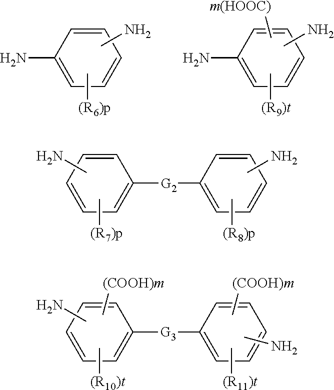
wherein p=4, m=1 or 2, and t=1 to 3, wherein R₆, R₇, R₈, R₉, R₁₀, R₁₁ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as a halogenated alkoxy, aryl, substituted aryl such as halogenated aryls, alkyl ester, and substituted alkyl esters, and combinations thereof. It is to be understood that each R₆ can be different, each R₇ can be different, each R₈ can be different, each R₉ can be different, each R₁₀ can be different, and each R₁₁ can be different. G₂ and G₃ are selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si (CH₃)₂ group; 9,9-fluorene group; substituted 9,9-fluorene; and an OZO group, wherein Z is a aryl group or substituted aryl group, such as phenyl group, biphenyl group, perfluorobiphenyl group, 9,9-bisphenylfluorene group, and substituted 9,9-bisphenylfluorene.

18. The solution according to claim 13, wherein at least one of terminals of the aromatic polyamide is end-capped.

19. A process for manufacturing a display element, an optical element or an illumination element, comprising the steps of:
forming the display element, the optical element or the illumination element on a surface of the organic resin layer of the laminated composite material according to claim 1, wherein the surface is not opposed to the glass plate.

20. The process according to claim 19, further comprising the step of:
de-bonding, from the glass plate, the display element, the optical element or the illumination element formed on the base.
